(19) United States
(12) Patent Application Publication
(10) Pub. No.: US 2026/0149248 A1
(43) Pub. Date: May 28, 2026

(54) Vehicle Wire Hider

(71) Applicant: KC IP HOLDINGS, LLC, Flagstaff, AZ (US)

(72) Inventors: Bobby Leang, Los Angeles, CA (US); Adriaan van Niekerk, Phoneix, AZ (US)

(21) Appl. No.: 18/963,180

(22) Filed: Nov. 27, 2024

(51) Int. Cl. H02G 3/04; H02G 3/00

(52) U.S. Cl. CPC H02G 3/0481; H02G 3/0406; H02G 3/0487; H02G 3/266

(57) ABSTRACT

A wire hider assembly attachable to a mounting surface has a concealment conduit defining a central passageway and a first retention coupling, an opposed second retention coupling engageable to the first retention coupling to close off the central passageway, and a first coupling. One or more retention clips are linkable with the concealment conduit in an interlocking relationship, with each of the one or more retention clips defined by an adhesive strip channel and a second coupling opposite thereto engageable to the first coupling of the concealment conduit. One or more double-sided adhesive strips each have a first side adherable to the adhesive strip channel of a respective one of the one or more retention clips and an opposed second side adherable to the mounting surface.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

### 1. Technical Field

The present disclosure relates generally to vehicle accessories, and more particularly to a vehicle wire hider.

### 2. Related Art

Motor vehicles are equipped with a variety of lighting devices that serve different purposes. For instance, headlamps positioned at the front of the vehicle and aimed in a forward direction help illuminate the roadway and the side peripheries thereof. The headlamp may have a low beam illuminator as well as a selectively activated high beam illuminator that provides longer range illumination but is intended to be used only in the absence of other nearby vehicles because of increased glare. The rear of the vehicle may be equipped with taillights that are typically activated together with the low beam headlamps, and provide conspicuity to other drivers to the rear of the vehicle. Additionally, there may be brake lamps that signal the activation of the brake and hence a reduction in speed, along with reverse lights that signal when the vehicle is travelling or about to travel in the reverse direction. Both the front and the rear of the vehicle may be equipped with turn signals on left and right sides that are selectively activated to signal to surrounding drivers an intent to change lanes, turn, or otherwise modify the direction of travel. These lights are mandated by law, and are regulated as to their color, intensity, and aiming angles. Accordingly, the lights are integrated into the overall vehicle design, with its wiring concealed within interior crevices of the vehicle structure.

In some cases, the original equipment lighting may be insufficient. Vehicles intended for off-road travel may require additional lighting for increased forward illumination of the trail to improve visibility and for hazard avoidance. Thus, light bars and/or arrays of individual luminaires may be mounted to the roof of the vehicle. Because original equipment tail lights may not have sufficient power to cut through heavy dust conditions common in off-road travel, there may be rearward-aimed chase lights mounted high on the rear of the vehicle.

Frequently associated with off-road vehicles is extended, self-sustained travel to remote locales, as off-road capability is a necessary prerequisite for access thereto. Such vehicles thus serve a dual purpose of providing basic living amenities, so kitchens, sleeping spaces, and so on become extensions of the vehicle. Illumination of these outside living spaces may be provided by external scene/flood lights mounted to the vehicle.

In most cases, the foregoing auxiliary lights are not directly integrated into the vehicle and are aftermarket products, so their wiring is external to existing vehicle electrical networks. The power source for the lights is typically the main battery that is located in the engine bay, while the controls for such auxiliary lights are separate from the original equipment. As such, the switches are mounted to available space on the dashboard or elsewhere within the vehicle cabin, with the switch circuit being wired to the battery through the firewall. Where there are several different auxiliary lights or other electrical devices installed on the vehicle that need to be independently controllable, a switch panel system that connects all of the electrical loads to the power source may be used. The switch panel system includes a relay junction unit installed in the engine bay or other accessible central location, with the wiring of the auxiliary devices routed thereto. A single transmission cable is then routed from the relay junction unit to the switch panel mounted in the cabin. Each of the switches in the panel can then activate the devices connected to the relay junction unit.

Regardless of the wiring modality employed, particularly for auxiliary lights or other electrical accessories mounted on the vehicle roof or at any location aft of the engine bay, it is necessary to route at least some segment of the wiring down the A-pillar. It may also be possible to route the wiring along the undercarriage of the vehicle, but such a configuration would be appropriate only for accessories that are mounted toward the bottom of the vehicle, such as lights mounted on the rear bumper. For any roof-mounted accessories, the wiring would still need to be routed down one pillar or another to bring it in vertical alignment with the engine bay.

In some cases, a hole may be drilled on the vehicle roof and the wiring passed through an interior of the A-pillar and into the engine bay. Although such a configuration avoids visibility of the writing, because the vehicle is exposed to rain and snow, moisture ingress through the opened hole becomes highly likely if not inevitable despite best efforts to seal the same. The resulting moisture can corrode the metal surfaces of the vehicle body as well as the wiring, leading to malfunctions.

Also known in the art are wire hiders such as those offered by KC HiLiTES, Inc. of Flagstaff, Arizona, which are extruded rubber strips that are adhered to the surface of the windshield with a double-sided adhesive strip such as 3M™ VHB™. The wiring may be routed through an interior channel of the flexible strip extending from the roof to near the engine bay. Although there is relative permanency with respect to the adhesive strip adhering to the glass surface of the windshield, due to the unavoidable mismatch between the thermal expansion rate of the wire hider strip and the adhesive strip, the wire hider does not remain adhered to the adhesive strip for an extended period of time, e.g., multiple years. Furthermore, because rubber strips are naturally impregnated with oil, the adhesion between a directly attached adhesive strip is less stable. The effects of exposure to the ultraviolet rays of the sun further degrades the rubber material of the wire hider, leading to its delamination from the adhesive strip. Moreover, because the adhesive strip must be affixed to the entire length, or at least a substantial entirety of the length of the wire hider strip, installation can be cumbersome. The rubber material of the wire hider strip tends to naturally curl, introducing creases along the adhesive strip that lead to air pockets at the interface between the adhesive strip and the wire hider, further contributing to the delamination.

Accordingly, there is a need in the art for an improved wire hider that remains adhered to the windshield for longer durations. There is also a need in the art for a wider hider that is easier to install and route in a variety of different configurations.

### BRIEF SUMMARY

The embodiments of the present disclosure are directed to wire hider assemblies attachable to a mounting surface. There may be a concealment conduit that defines a central passageway. The concealment conduit may also include a first retention coupling and an opposed second retention coupling engageable to the first retention coupling to close off the central passageway. Additionally, the concealment conduit may include a first coupling. The assembly may include one or more retention clips that are linkable with the concealment conduit in an interlocking relationship. Each of the one or more retention clips may be defined by an adhesive strip channel and a second coupling opposite thereto which may be engageable to the first coupling of the concealment conduit. The assembly may include one or more double-sided adhesive strips each having a first side adherable to the adhesive strip channel of a respective one of the one or more retention clips and an opposed second side adherable to the mounting surface.

Another embodiment of the present disclosure is a wire hider retention clip. There may be a clip body that is defined by a platform, feet, and arms. The feet may downwardly extend from the platform along the elongate sides of the clip body. The arms may upwardly extend from the platform along the elongate sides of the clip body. A bottom face of the platform and the feet may define an adhesive strip channel. A top face of the platform and the arms may define a conduit engagement channel. Each of the arms may further define one or more wedge hook segments inwardly facing the conduit engagement channel.

Yet another embodiment may be a wire concealment conduit. There may be an elongated conduit body that defines a central passageway. The conduit body may have a first retention coupling, a second retention coupling engageable to the first retention coupling to close off the central passageway, and a coupling channel with a rail and diagonal notch troughs on opposing sides of the rail. The conduit body may further define a first outer wall and a second outer wall. The coupling channel may be between the first outer wall and the second outer wall. The outer walls may each extend beyond the rail.

The present disclosure will be best understood accompanying by reference to the following detailed description when read in conjunction with the drawings.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 illustrates a wire hider assembly according to one embodiment of the present disclosure installed on a vehicle windshield;

FIG. 2 is an exploded perspective view of the wire hider assembly with a concealment conduit separated from multiple retention clips;

FIG. 3 is a top perspective view of the retention clip;

FIG. 4 is a bottom perspective view of the retention clip;

FIG. 5 is a cross-sectional view of the wire hider assembly with the concealment conduit separated from the retention clip taken along axis 5,6 of FIG. 2;

FIG. 6 is a cross-sectional view of the wire hider assembly with the concealment conduit coupled to the retention clip taken along axis 5,6 of FIG. 2; and

FIG. 7 is a cross-sectional view of another variation of the concealment conduit in which its central passageway has an oval profile.

### DETAILED DESCRIPTION

The detailed description set forth below in connection with the appended drawings is intended as a description of the several presently contemplated embodiments of a wire hider assembly and its constituent concealment conduit and retention clips. It is not intended to represent the only form in which such embodiments may be developed or utilized. The description sets forth the functions and features in connection with the illustrated embodiments. It is to be understood, however, that the same or equivalent functions may be accomplished by different embodiments that are also intended to be encompassed within the scope of the present disclosure. It is further understood that the use of relational terms such as top and bottom, left and right, and first and second and the like are used solely to distinguish one from another entity without necessarily requiring or implying any actual such relationship or order between such entities.

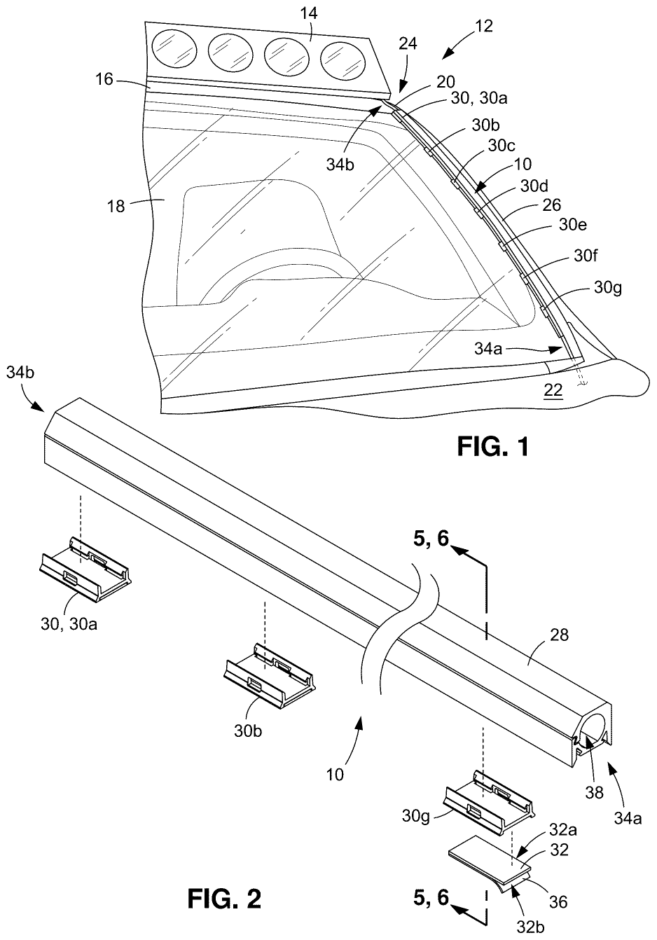

Referring now to FIG. 1, one embodiment of a wire hider assembly 10 is shown installed on a vehicle 12. In this exemplary installation, the vehicle 12 is equipped with auxiliary lighting, which may be a light bar 14 that provides additional illumination. The light bar 14 is installed on a roof 16 of the vehicle 12, above its windshield 18. As the light bar 14 requires electrical power to operate, a wiring harness 20 is connected to a power source, e.g., a battery, typically located within an engine bay 22 of the vehicle 12. The wiring harness 20 is comprised of at least a pair of wires—one wire for power, and another for common/ground. Because the light bar 14 is selectively activated, either the power connection or the common connection may be switched. With additional electrical accessories, whether they are lighting or otherwise, there may be additional pairs of wires corresponding to each such accessory. The wiring harness 20 may bundle all of the wires of such roof-mounted electrical accessories at the apex 24 of the vehicle A-pillar 26, or there may be individual strands or bundled pairs of wires.

Regardless of the specific wiring configuration, according to one embodiment of the present disclosure, the wiring harness 20 is routed down the side of the windshield 18 toward the engine bay 22, along the vehicle A-pillar 26. This is understood to minimize obstructions on the windshield 18 interfering with the driver's visibility. Further, with the use of the wire hider assembly 10 in accordance with various embodiments of the present disclosure, the wiring harness 20 may be hidden from view and avoid detracting from the overall visual appeal of the vehicle 12. Rather, as will be described in further detail below, the wire hider assembly 10 provides a single, uniform, and inconspicuous structure that visually blends with vehicle exterior features. Although FIG. 1 illustrates the wire hider assembly 10 installed on the windshield 18 to route wires between the apex 24 of the vehicle A-pillar 26 and the engine bay 22, this is by way of example only and not of limitation. It is expressly contemplated that the wire hider assembly 10 may be utilized in any other location of the vehicle 12.

With reference now to FIG. 2, the wire hider assembly 10 includes a concealment conduit 28, one or more retention clips 30, and one or more double-sided adhesive strips 32. The concealment conduit 28 may be a single, elongated structure with opposed open ends 34a, 34b, and define a central passageway 38 through which the wiring harness 20 may be passed. As shown in FIG. 1, the concealment conduit 28 is sized to extend a substantial entirety of the windshield 18 with the first open end 34a being proximal to a bottom end of the windshield 18, and the second open end 34b being proximal to the top end of the windshield 18 near the apex 24 of the A-pillar 26a. It will be appreciated that the size of the windshield 18 varies depending on vehicle 12, but the sizing of the concealment conduit 28 is understood to be universal to accommodate the vast majority of vehicles. It is expressly contemplated that the concealment conduit 28 can be trimmed to the appropriate size.

The one or more retention clips 30 are positioned along the desired conduit routing path. In the installation of FIG. 1, there are seven retention clips 30a-30g spaced at regular intervals, though this is by way of example only. Any suitable spacing and number of retention clips 30 may be used in a given installation of the wire hider assembly 10, and each of the retention clips 30a-30g are understood to be identical.

In order to mount the retention clips 30 to a vehicle surface, the double-sided adhesive strip 32 is affixed thereto. Specifically, the double-sided adhesive strip 32 has a top adhesive surface 32a that is adhered to the retention clip 30, and a bottom adhesive surface 32b that is adhered to the vehicle 12, or more specifically in the illustrated example, the glass surface of the windshield 18. The double-sided adhesive strip 32 therefore has a length commensurate with the length of the retention clip 30, or slightly undersized relative thereto. The width dimension is also limited to the retention clip 30, though additional details of the constraints will be described more fully below. Both the top adhesive surface 32a and the bottom adhesive surface 32b may initially be covered with protective film 36 that prevents contaminants from collecting thereon but removed by the installer before affixation to the retention clip 30 and the vehicle surface. Any suitable double-sided adhesive strip 32 may be utilized, but preferably, though optionally, it may be 3M™ VHB™ tape.

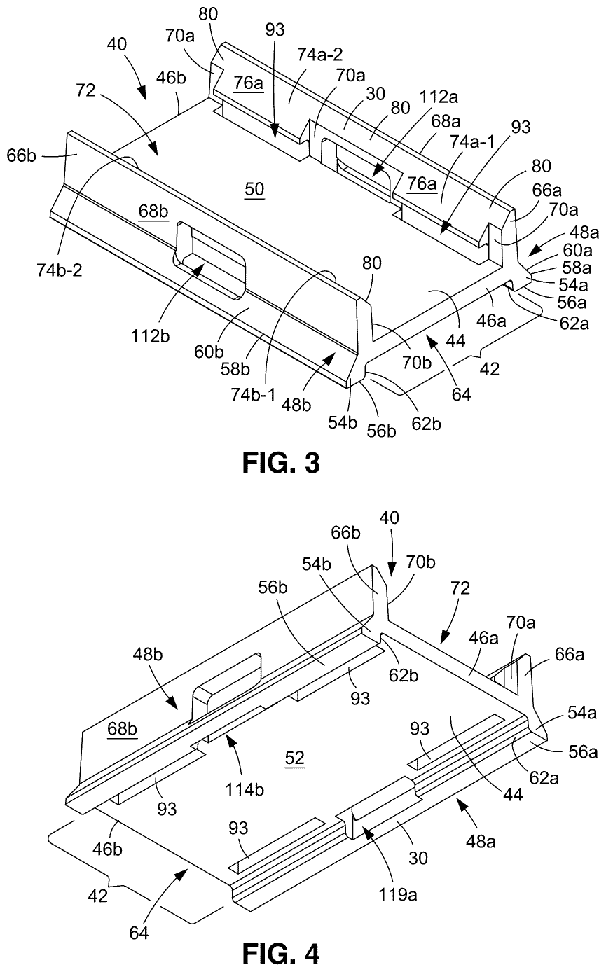

With the retention clips 30 adhered to the vehicle surface, the concealment conduit 28 may be linked or coupled to the retention clips 30 in an interlocking relationship. Referring now to FIGS. 3, 4, 5, and 6, the retention clip 30 is defined by a conduit coupling 40, also referred to as a second coupling, while the concealment conduit 28 defines a clip coupling 42, also referred to as a first coupling. The conduit coupling 40 of the retention clip 30 is interlocked with the clip coupling 42 of the concealment conduit 28, linking the concealment conduit 28 to the retention clip 30.

The retention clip 30 is characterized by a clip body of a unitary structure, though there are separate parts thereof as will be detailed more fully below. In particular, there is a platform 44 with a generally elongated quadrangular/rectangular shape with opposed lateral edges 46a, 46b and opposed longitudinal sides 48a, 48b. The platform 44 is further defined by platform top surface 50 and an opposed platform bottom surface 52. The particular shape of the retention clip 30 is also presented by way of example only and not of limitation. The features of the retention clip 30 described herein may be adopted for other shapes such as transition bends (90 degrees, 45 degrees, etc.) to change the direction of routing the concealment conduit 28, interconnect multiple separated parts of the concealment conduit 28 with retention clips 30 having extended lengths, and so on.

Extending downwardly and outwardly from the platform 44 are feet 54, including a first foot 54a on the first longitudinal side 48a, and a second foot 54b on the second longitudinal side 48b. The feet 54 each define a bottom surface 56, with the first foot 54a defining a bottom surface 56a and the second foot defining a bottom surface 56b. The feet 54 are also defined by an outer vertical sidewall 58 and an outer angled sidewall 60. Specifically, the first foot 54a defines an outer vertical sidewall 58a and an outer angled sidewall 60a, and the second foot 54b defines an outer vertical sidewall 58b and an outer angled sidewall 60b. Opposite the outer vertical sidewalls 58 are inner vertical sidewalls 62, including a first inner vertical sidewall 62a of the first foot 54a and a second inner vertical sidewall 62b of the second foot 54b. The inner vertical sidewalls 62 and the bottom surface 52 of the platform 44 together define an adhesive strip channel 64 that is receptive to the double-sided adhesive strip 32. The dimensions of the inner vertical sidewalls 62 may be dependent on the thickness of double-sided adhesive strip 32. In a preferred embodiment, the double-sided adhesive strip 32 has a foam base that is compressible, but in order for the bottom adhesive surface 32b to contact the vehicle mount surface at initial installation, the inner vertical sidewalls 62 may be dimensioned slightly less than the thickness of the double-sided adhesive strip 32 with minimal compressive forces applied thereto. The feet 54 are contemplated to at least partially conceal the edges of the double-sided adhesive strip 32 to minimize exposure to debris and moisture.

Extending upwardly from the platform 44 are arms 66, with a first arm 66a on the first longitudinal side 48a and a second arm 66b on the second longitudinal side 48b. Each of the arms 66 are defined by an outer wall 68, including a first outer wall 68a for the first arm 66a, and a second outer wall 68b for the second arm 66b. The outer walls 68 extend from the respective outer angled sidewalls 60 and are contiguous therewith. The arms 66 are each also defined by an inner wall 70, including a first inner wall 70a for the first arm 66a and a second inner wall 70b for the second arm 66b. The top surface 50 of the platform, together with the arms 66, define a conduit engagement channel 72 that is receptive to the clip coupling 42 of the concealment conduit 28. As will be described more fully below, the clip coupling 42 may be a rail in some embodiments, so the conduit engagement channel 72 may also be referred to as a rail engagement channel.

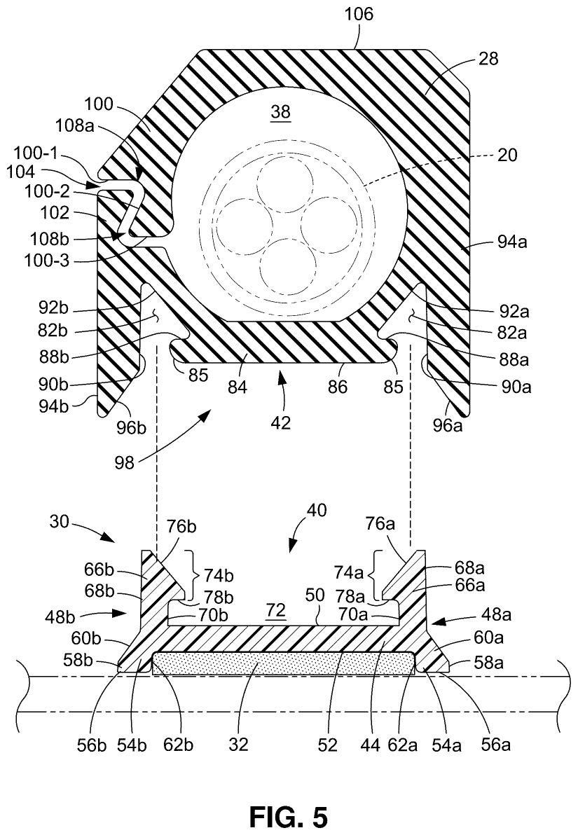

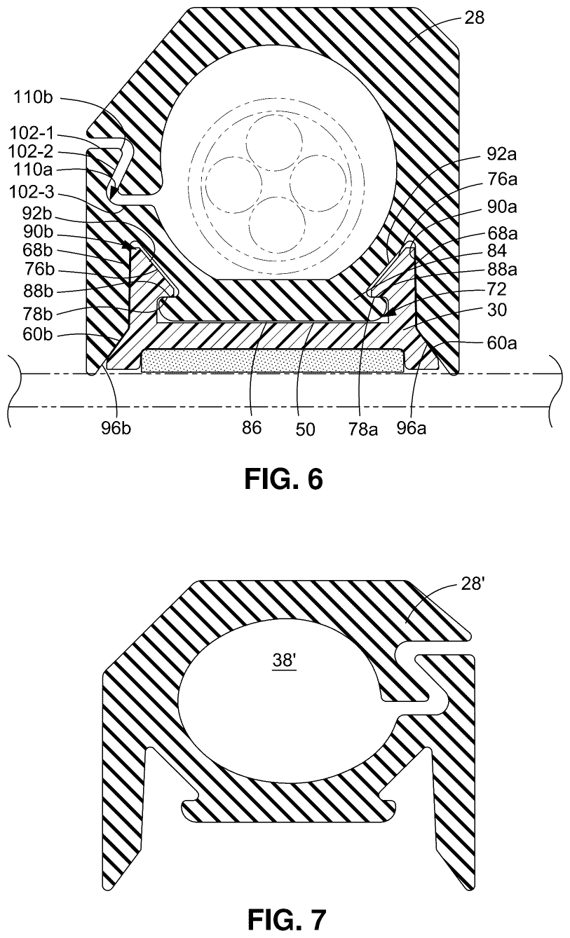

One part of the interlocking mechanism is a wedge hook segment 74 that is contiguous with a given one of the arms 66. The wedge hook segment 74 and the arm 66 may be referred together as hook extensions. Specifically, the first arm 66a includes a first wedge hook segment 74a-1 and a second wedge hook segment 74a-2 that is spaced apart from the first wedge hook segment 74a-1. Likewise, the second arm 66b includes a first wedge hook segment 74b-1 and a second wedge hook segment 74b-2 spaced apart from the first wedge hook segment 74b-1. The cross-sectional view of FIG. 5 and FIG. 6 illustrate both the first and second wedge hook segments of a given one of the arms 66, so both will be referenced together as wedge hook segment 74a (for the first arm 66a) and wedge hook segment 74b (for the second arm 66b). It is to be understood that the following detailed features are included in each of the individual wedge hook segments 74a-1, 74a-2, 74b-1, and 74b-2.

The first arm wedge hook segments 74a include a diagonal surface 76a that faces inwardly towards the conduit engagement channel 72, and the second arm wedge hook segments 74b include a diagonal surface 76b that likewise faces inwardly toward the conduit engagement channel 72. Each of the wedge hook segments 74 also have a rail engagement surface 78, that is, the first arm wedge hook segments 74 define a first rail engagement surface 78a and the second arm wedge hook segments 74 define a second rail engagement surface 78b. The first and second rail engagement surfaces 78 are understood to be parallel to the top surface 50 of the platform 44. The diagonal surfaces 76 may taper to a point that is shared with the respective one of the outer walls 68, or there may be a small flat/horizontal transition surface between the two. Similarly, the diagonal surfaces 76 may taper to a point that is shared with the respective one of the rail engagement surfaces 78, or there may be a small vertical transition surface between the two.

In some embodiments, the entire length of the arms 66 has an upper end diagonal surface 80 that is coplanar with the diagonal surface 76 of the wedge hook segments 74. The arms 66 are inserted into corresponding notch channels 82, also referred to as diagonal notch troughs, which extend the entire length of the concealment conduit 28. The notch channels 82 are defined at the bottom portion of the concealment conduit 28 and are a part of the interlocking mechanism of the clip coupling 42.

In addition to the notch channels 82, the clip coupling 42 includes a rail 84 with a bottom rail surface 86. As detailed in FIG. 6, the rail 84 is received within the conduit engagement channel 72 of the retention clip 30. The rail 84 is also defined by a first hook engagement surface 88a that partly defines the first notch channel 82a, and a second hook engagement surface 88b that partly defines the second notch channel 82b. With the concealment conduit 28 and the retention clip 30 fully coupled, the first hook engagement surface 88a faces and/or abuts against the first rail engagement surface 78a, and the second hook engagement surface 88b faces and/or abuts against the second rail engagement surface 78b. The notch channels 82 are each defined by respective inner vertical walls 90a, 90b that are in an abutting relationship with the outer wall 68a, 68b of the arms 66a, 66b, respectively. Additionally, the notch channels 82 are each defined by inner diagonal surfaces 92a, 92b that conform to the diagonal surfaces 76a, 76b of the wedge hook segments 74a, 74b.

The separation of the concealment conduit 28 from the retention clips 30 is intended to be more difficult as the permanent installation state of the wire hider assembly 10 is with such components coupled together. Furthermore, the initial attachment of the concealment conduit 28 to the retention clips 30 is intended to be achieved without excessive force or manipulation. To this end, insertion of the arms 66 into the notch channels 82 is intended to be aided by the angled shape of the wedge hook segments 74, as well as the rounded corners 85 of the rail 84. The retention clips 30 may be injection molded with a rigid plastic material, whereas the concealment conduit 28 is a flexible rubber material. Accordingly, the while the retention clip 30, and hence the arms 66/wedge hook segments 74 remain relative rigid, the rail 84 is contemplated to deform such that the space between the rail 84 and the inner vertical walls 90 expands to allow for the insertion of the arms 66.

Once the wedge hook segments 74 are fully inserted into the notch channels 82, the abutting interface between the rail engagement surface 78 of the wedge hook segments 74 and the hook engagement surface 88 of the rail 84 interlocks the two components. Although the rail 84 can be deformed to withdraw the arms 66/wedge hook segments 74 from the notch channels 82, a substantially greater amount of force will be needed to do so in comparison to the reverse.

As best shown in FIGS. 3 and 4, in order for the arms 66 to flex to such an extent that insertion and removal is facilitated, those portions of the platform 44 coinciding with the wedge hook segments 74 may define openings 93. These are understood to slightly increase the deflection angle of the junction between the platform 44 and the arms 66.

The concealment conduit 28 is generally defined by a first wall 94a and a second wall 94b, both the walls 94 extending beyond the clip coupling 42. The first wall 94a defines an inner diagonal surface 96a that conforms to the outer angled sidewall 60a of the first foot 54a, and the second wall 94b defines an inner diagonal surface 96b that conforms to the outer angled sidewall 60b of the second foot 54b. As shown in FIG. 6, with the concealment conduit 28 coupled to the retention clip 30, the first wall 94a and the second wall 94b are understood to conceal the retention clips 30. In particular, the inner diagonal surface 96a faces and abuts against the outer angled sidewall 60a, and the inner diagonal surface 96b faces and abuts against the outer angled sidewall 60b. The inner diagonal surfaces 96, together with the notch channels 82 and the rail 84 generally define a wider coupling channel 98 that is receptive to and encompasses the retention clip 30.

A specific modality of coupling the concealment conduit 28 to the retention clip 30 has been described, but this is by way of example only and not of limitation. For instance, the halves of the interlocking mechanism may be reversed as to the concealment conduit 28 and the retention clip 30, where the retention clip 30 incorporates the coupling 42 instead of the coupling 40, and the concealment conduit 28 incorporates the coupling 40 instead of the coupling 42. Furthermore, any other suitable coupling modality other than the rail and hook modality disclosed herein may be substituted without departing from the scope of the present disclosure.

As noted above, the retention clip 30 is injection molded with a rigid plastic material. With the double-sided adhesive strips 32 being the modality by which the wire hider assembly 10 is attached to the vehicle surface, it is expressly contemplated that this adhesive interface is attached to materials of like rigidity and thermal expansion characteristics. Avoiding a mismatch on one side, such as would be the case with a rubber conduit directly attached to the double-sided adhesive strip 32, is understood to reduce the likelihood of detachment from the adhesive. This configuration also avoids the direct attachment of the adhesive strip 32 to the oil-impregnated rubber concealment conduit 28. In other words, the adhesion of the plastic retention clip 30 to the double-sided adhesive strips 34 is significantly improved because the plastic material provides a superior bonding surface therefor. The retention clip 30, in turn, mechanically secures the concealment conduit 28 to the vehicle mount surface. Although a rubber concealment conduit 28 and a plastic retention clip 30 have been disclosed, any other suitable materials that follow these principles may be substituted. Generally, the concealment conduit 28 may be constructed of a first material that is different from a second material of the retention clip 30, with that second material being more rigid or is closer in material parameters to the mounting surface than the first material.

The concealment conduit 28 of the present disclosure is further defined by a first retention coupling 100 and an opposed second retention coupling 102 that is engageable to the first retention coupling 100 to close off the central passageway 38. In the embodiment shown in FIGS. 5 and 6, the opening or gap 104 between the first retention coupling 100 and the second retention coupling 102 is oriented sideways, so that a top face 106 remains fully closed. In this illustrated embodiment, the retention couplings 100, 1002 may take the form of interlocking clasp jaws, though this is by way of example only and not of limitation.

The first retention coupling 100 and the second retention coupling 102 have a complementary interlocking profile in accordance with one embodiment. As shown in the exemplary illustration, this interlocking profile may be a Z-shape, though any other desirable interlocking profile may be substituted without departing from the scope of the present disclosure. In particular, the first retention coupling 100 has a top flat segment 100-1, a diagonal segment 100-2, and a bottom flat segment 100-3. The transition between the top flat segment 100-1 and the diagonal segment 100-2 defines a first retention coupling recess 108a, and the transition between the diagonal segment 100-2 and the bottom flat segment 100-3 defines a first retention coupling projection 108b. The second retention coupling 102 likewise has a flat top segment 102-1, a diagonal segment 102-2, and a bottom flat segment 102-3. The transition between the bottom flat segment 102-3 and the diagonal segment 102-2 defines a second retention coupling recess 110a, and the transition between the diagonal segment 102-2 and the top flat segment 102-1 defines a second retention coupling projection 110b. Thus, the first retention coupling recess 108a is complementary with the second retention coupling projection 110b, and the first retention coupling projection 108b is complementary with the second retention coupling recess 110a.

The foregoing configuration of the first and second retention couplings 100, 102 allows the interlocking of the two. To the extent a radial force is directed against the interior of the central passageway 38, it is understood to expand the first retention coupling 100 outwards, forcing the diagonal segment 100-2 of the first retention coupling 100 against the diagonal segment 102-2 of the second retention coupling 102. The second retention coupling 102 prevents the substantial opening of the gap 104, and the ejection of the wiring harness 20 from the central passageway 38. This is intended to at least prevent the inadvertent separation of the first retention coupling 100 and the second retention coupling 102. Exerting additional force to overcome the frictional retention between the first retention coupling 100 and the second retention coupling 102 can still separate the two, providing access into the central passageway 38.

The embodiment of the concealment conduit 28 shown in FIGS. 5 and 6 illustrates the central passageway 38 with a circular profile. FIG. 7 shows a cross-sectional view of another embodiment of the concealment conduit 28′ defining a central passageway 38′ with an oval profile. It will be recognized by those having ordinary skill in the art that any suitable profile of the central passageway 38 may be substituted, with corresponding modifications made to different dimensions of the concealment conduit 28 and/or the retention clips 30.

Another embodiment of the wire hider assembly 10 envisions the omission of the concealment conduit 28, with the wiring harness 20 being directly attached and routed through the retention clips 30. To this end, the outer walls 68 may define a retainer passageway 112. Specifically, the first outer wall 68a may define a first retainer passageway 112a and the second outer wall 68b may define a second retainer passageway 112b. The first retainer passageway 112a and the second retainer passageway 112b are axially aligned and centered along the body of the retention clip 30. The retainer passageways 112 provide access to both above and below the platform 44, so it extends partially into the feet 54/outer angled sidewall 60. In this regard, the platform 44 further defines vertical openings 114 coinciding with the retainer passageways 112.

With the wiring harness 20 placed directly onto the platform 44, a zip tie, wire, or other like retainer can be passed through the first retainer passageway 112a, towards the region underneath the platform 44 through the vertical opening 114a, across the platform 44, up through the vertical opening 114b, and the second retainer passageway 112b. The retainer can then be cinched down against the wiring harness 20 and the top edges of the arms 66.

The wire hider assembly 10 thus configured is envisioned to improve the longevity of the adhesion between the retention clip 30 and the vehicle surface. Furthermore, the surface area of bonding to the vehicle surface may be reduced, and improvements in the installation process are contemplated because of the modular configuration of the separate retention clip 30 and concealment conduit 28.

The particulars shown herein are by way of example and for purposes of illustrative discussion of the embodiments of a wire hider assembly and its constituent concealment conduit and retention clips and are presented in the cause of providing what is believed to be the most useful and readily understood description of the principles and conceptual aspects. In this regard, no attempt is made to show details with more particularity than is necessary, the description taken with the drawings making apparent to those skilled in the art how the several forms of the present disclosure may be embodied in practice.

What is claimed is:

1. A wire hider assembly attachable to a mounting surface, comprising:
a concealment conduit defining a central passageway and including a first retention coupling, an opposed second retention coupling engageable to the first retention coupling to close off the central passageway, and a first coupling;
one or more retention clips linkable with the concealment conduit in an interlocking relationship, each of the one or more retention clips being defined by an adhesive strip channel and a second coupling opposite thereto engageable to the first coupling of the concealment conduit; and
one or more double-sided adhesive strips each having a first side adherable to the adhesive strip channel of a respective one of the one or more retention clips and an opposed second side adherable to the mounting surface.

2. The wire hider assembly of claim 1, wherein the first coupling is a rail, and the second coupling is a rail engagement channel.

3. The wire hider assembly of claim 2, wherein:
the concealment conduit further defines a pair of notch channels; and
each of the one or more retention clips includes one or more hook extensions conforming to either one or the other of the pair of notch channels for receptive engagement therein.

4. The wire hider assembly of claim 3, wherein the retention clip has a first sidewall and a second sidewall that together with a base platform define the rail engagement channel.

5. The wire hider assembly of claim 4, wherein given ones of the hook extensions are contiguous with a corresponding one of the first and second sidewalls.

6. The wire hider assembly of claim 4, wherein the first sidewall and the second sidewall each define a retainer passageway, the retainer passageway of the first sidewall being in axial alignment with the retainer passageway of the second sidewall.

7. The wire hider assembly of claim 1, wherein the first retention coupling defines a projection complementary with a recess defined by the second retention coupling.

8. The wire hider assembly of claim 7 wherein the first retention coupling defines a recess complementary with a projection defined by the second retention coupling.

9. The wire hider assembly of claim 8, wherein the first retention coupling and the second retention coupling have an interlocking profile.

10. The wire hider assembly of claim 1, wherein:
the concealment conduit is constructed of a first material; and
the one or more retention clips are constructed of a second material with more rigidity than the first material of the concealment conduit.

11. The wire hider assembly of claim 10, wherein the first material is a rubber material and the second material is a plastic material.

12. A wire hider retention clip, comprising:
a clip body defined by a platform, feet downwardly extending from the platform along the elongate sides of the clip body, and arms upwardly extending from the platform along the elongate sides of the clip body, a bottom face of the platform and the feet defining an adhesive strip channel, and a top face of the platform and the arms defining a conduit engagement channel, each of the arms further defining one or more wedge hook segments inwardly facing the conduit engagement channel.

13. The wire hider retention clip of claim 12, wherein the arms each define an outer sidewall opposite the wedge hook segments.

14. The wire hider retention clip of claim 13, wherein given ones of the arms, feet, and a portion of the platform proximal thereto define at least a part of a retainer passageway.

15. The wire hider retention clip of claim 12, wherein the clip body is constructed of a rigid plastic material.

16. A wire concealment conduit, comprising:
an elongated conduit body defining a central passageway, the conduit body having a first retention coupling, a second retention coupling engageable to the first retention coupling to close off the central passageway, and a coupling channel with a rail and diagonal notch troughs on opposing sides of the rail, the conduit body further defining a first outer wall and a second outer wall with the coupling channel being between the first outer wall and the second outer wall, and the outer walls each extending beyond the rail.

17. The wire concealment conduit of claim 16, wherein:
the first retention coupling defines a projection complementary with a recess defined by the second retention coupling; and
the first retention coupling defines a recess complementary with a projection defined by the second retention coupling.

18. The wire concealment conduit of claim 16, wherein the central passageway has a circular profile.

19. The wire concealment conduit of claim 16, wherein the central passageway has an oval profile.

20. The wire concealment conduit of claim 16, wherein the elongated conduit body is constructed of a flexible rubber material.
